(19) United States
(12) Patent Application Publication
(10) Pub. No.: US 2003/0061098 A1
(43) Pub. Date: Mar. 27, 2003

(54) Consumer incentive system

(76) Inventor: Jason Meyer, Abbotsford (AU)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/245,149

(22) Filed: Sep. 17, 2002

(30) Foreign Application Priority Data
Sep. 26, 2001 (AU) PR7931

(51) Int. Cl. G06F 17/60

(52) U.S. Cl. 705/14

(57) ABSTRACT

The present invention relates to a system for encouraging consumers to patronize predetermined providers of goods and/or services. The system is particularly well suited to providing an incentive for consumers to shop at particular shopping centers that house the retail outlets for several different businesses. However, the invention is not limited to shopping centers, or shopping malls as they have become known, and may be used by any businesses regardless of the geographic location.

### BACKGROUND OF THE INVENTION

The present invention relates to a system for encouraging consumers to patronize predetermined providers of goods and/or services. The system is particularly well suited to providing an incentive for consumers to shop at particular shopping centers that house the retail outlets for several different businesses. However, the invention is not limited to shopping centers, or shopping malls as they have become known, and may be used by any businesses regardless of the geographic location. For example, transactions conducted over the Internet would be suitable for this invention. It may also be applied to electronically tagged vehicles using motorways requiring payment of a toll.

In general terms, retail trading has become progressively more competitive. As the range and number of retailers for various goods increases, so does the consumer's sophistication and ability to negotiate better deals. This puts an increasing downward pressure on the retailer's profit margins.

To combat the erosion of profit margins, various incentive and loyalty schemes have been developed to attract business on the basis of factors other than simply the lowest price. Many of these schemes reward a customer's continued patronage by accumulating points linked to their levels of expenditure. The consumer can then redeem the points for gifts or discounts on future purchases.

These incentive schemes effectively ascribe a monetary value to the points which the scheme administrators use to calculate the number of points required for each reward. However, to contain the cost of the reward scheme, the value of each point is relatively low and most consumers have spending habits that take a long time to accumulate the points required to redeem a modest reward. This tends to diminish the incentive and consumers begin to realize that negotiating a better deal, or seeking out a cheaper supplier, ultimately gives them a better return than adhering to the reward scheme.

More recently, an incentive scheme was proposed which incorporates the appeal of a lottery and does not necessarily require the consumer to patronize the participating retailers for a long time before getting a reward. A cash prize is randomly selected and kept secret from consumers until it is won. A percentage of the purchases from participating retailers is recorded and accumulated so that the total slowly increments towards the unknown prize amount. The accumulating cash total is prominently displayed so that the incentive correspondingly increases until the prize is won. The individual transaction that causes the total to equal the randomly chosen prize is identified and awarded the money. Unfortunately, because this system relies on a fixed relationship between the accumulated transaction information and the randomly selected cash prize, the incentive is removed, or at least diminished, after the prize has been won.

### SUMMARY OF THE INVENTION

In accordance with the present invention there is provided, a consumer incentive system that overcomes or ameliorates at least one of the disadvantages of the earlier systems, or provides a useful alternative thereto.

Further, in accordance with the present invention, there is provided a consumer incentive system for awarding a prize to at least one consumer comprising:

at least one electronic transaction device which facilitates the purchase of goods or services;

a system controller linked to the at least one electronic device for receiving selected transaction information, wherein the selected transaction information includes at least one transaction detail selected from the group consisting of:

transaction number;

transaction time

transaction amount;

transaction type; and

category of consumer;

wherein the controller is programmable to:

accumulate at least one of the transaction details and maintain a progressive total of the at least one transaction detail;

select an accumulated total of the at least one transaction detail to be a trigger value;

compare the progressive total to the trigger value; and

award the prize to the consumer involved in the transaction which causes the progressive total to meet or exceed the trigger value.

Still further, in accordance with the present invention, there is provided a method of awarding a prize to at least one consumer purchasing goods and/or services via at least one electronic transaction device linked to a system controller, the method comprising:

transmitting selected transaction information from the at least one transaction device to the controller, wherein the selected transaction information includes at least one transaction detail selected from the group consisting of:

transaction number;

transaction time;

transaction amount;

transaction type; and

category of consumer;

accumulating at least one of the transaction details and maintaining a progressive total of the at least one transaction detail;

selecting an accumulated total of the at least one transaction detail to be a trigger value;

comparing the progressive total to the trigger value; and

awarding the prize to the consumer involved in the transaction which causes the progressive total to meet or exceed the trigger value.

Still further, in accordance with the present invention, there is provided a system controller for a system of awarding a prize to at least one consumer of goods and/or services purchased using at least one electronic transaction devices comprising:

a microprocessor;

means adapted to receive selected transaction information from the at least one electronic transaction device, wherein the selected transaction information includes at least one transaction detail selected from the group consisting of:

transaction number;

transaction time;

transaction amount;

transaction type; and

category of consumer;

wherein the microprocessor is programmable to:

accumulate at least one of the transaction details and maintain a progressive total of the at least one transaction detail;

select an accumulated total of at least one the transaction detail to be a trigger value; and

compare the progressive total to the trigger value and identify the consumer involved in the transaction which causes the progressive total to meet or exceed the trigger value such that the consumer is the prize winner.

In a preferred embodiment, the accumulated total of the transaction detail chosen to be the trigger value is randomly selected thereby making the trigger value randomly generated. Randomly selecting the trigger value helps to maintain the incentive immediately after the award of a prize.

Preferably, a prominently positioned display screen is linked to the controller for showing consumers the prize. In a further preferred embodiment, at least two separate businesses each have at least one electronic transaction device. In a still further preferred embodiment, each of the separate businesses has at least one of the display screens showing the prize.

In a preferred embodiment, the controller randomly selects a transaction number as the trigger value. In a further preferred embodiment, several prizes are arbitrarily selected and the controller assigns each of the prizes a respective trigger value. In one embodiment, the respective trigger values are randomly selected from different types or combinations of the transaction details. In a further preferred embodiment, each of the displays show the prizes and the associated type of transaction detail from which the trigger value was randomly selected.

In order to discourage customers from deliberately breaking their shopping down into a series of smaller separate transactions, such as purchasing ten items individually rather than a single transaction for the purchase of ten items, the system can be configured to only recognize transactions that exceed a certain value. In another preferred embodiment, only transactions having a value within a certain range will be added to the progressive total and/or considered eligible for the award one of the prizes. In a still further preferred embodiment, the prizes are each selected from goods or services provided by the businesses using the incentive system.

In some embodiments, the controller is adapted to randomly select transaction numbers to be the respective trigger values for each of the prizes. The controller is programmed with an upper and lower limit of transaction numbers from which the respective trigger value transaction numbers are randomly selected for each prize such that the respective transaction numbers are selected from different ranges of transaction numbers and the range assigned to each prize can be used as a rough guide as to the cost of each of the selected prizes.

An incentive system according to the present invention is not restricted to cash prizes that are a set proportion of the particular transaction detail being progressively totaled. As the prizes are arbitrarily selected and have a fixed value, the incentive to the consumer is not diminished once one of the prizes has been won. Furthermore, the system can offer prizes in the form of goods or services provided by the participating businesses. Hence, the cost of the prize to the participating businesses would be a “wholesale” cost, whereas the value to the consumer would be the retail value of the prize. In this way, the system can offer prizes that provide relatively more incentive for less cost compared to a system that is limited to cash prizes only. Furthermore, the prizes can be linked to certain promotional themes, such as Christmas, Easter or major sporting events, such as football grand finals, Soccer World Cup and so on. This arrangement also allows the system to offer more attractive prizes during times when the shopping mall traditionally has less patronage or to compete with promotions at competing malls.

Electronic transaction devices, such as modern cash registers or the Internet, can be easily adapted to monitor and transmit various transaction details. The prizes can be awarded on the basis of a randomly selected number of transactions, a random amount of the accumulated dollars transacted, certain transaction types, such as the purchase of particular products, particular brands, or payment by credit card and what type of credit card has been used. The system can also be adapted to recognize certain categories of consumer, such as members of affiliated loyalty schemes or local sporting and social clubs. This can conveniently facilitate cross-promotional programs involving the system administrators and any other clubs or loyalty schemes involved.

For simplicity, it is convenient to program the system controller to count the number of transactions and compare the total to the randomly chosen transaction number. Monitoring several different types of transaction detail allows the system to award a prize after a randomly chosen number of transactions within a certain dollar range, after a random number of transactions using a particular type of credit card, or a random number of transactions by consumers who identify themselves as members of an affiliated organization like a sporting or social club. This flexibility allows the system to offer different prizes of different value by tailoring the incentive to attract a broad range of individual market segments.

### BRIEF DESCRIPTION OF THE DRAWING

Preferred embodiments will now be described by way of example only with reference to the accompanying drawing in which:

FIG. 1 shows a schematic representation of an incentive system according to the present invention applied to a number of different retail outlets.

### DETAILED DESCRIPTION OF THE PREFERRED EMBODIMENTS

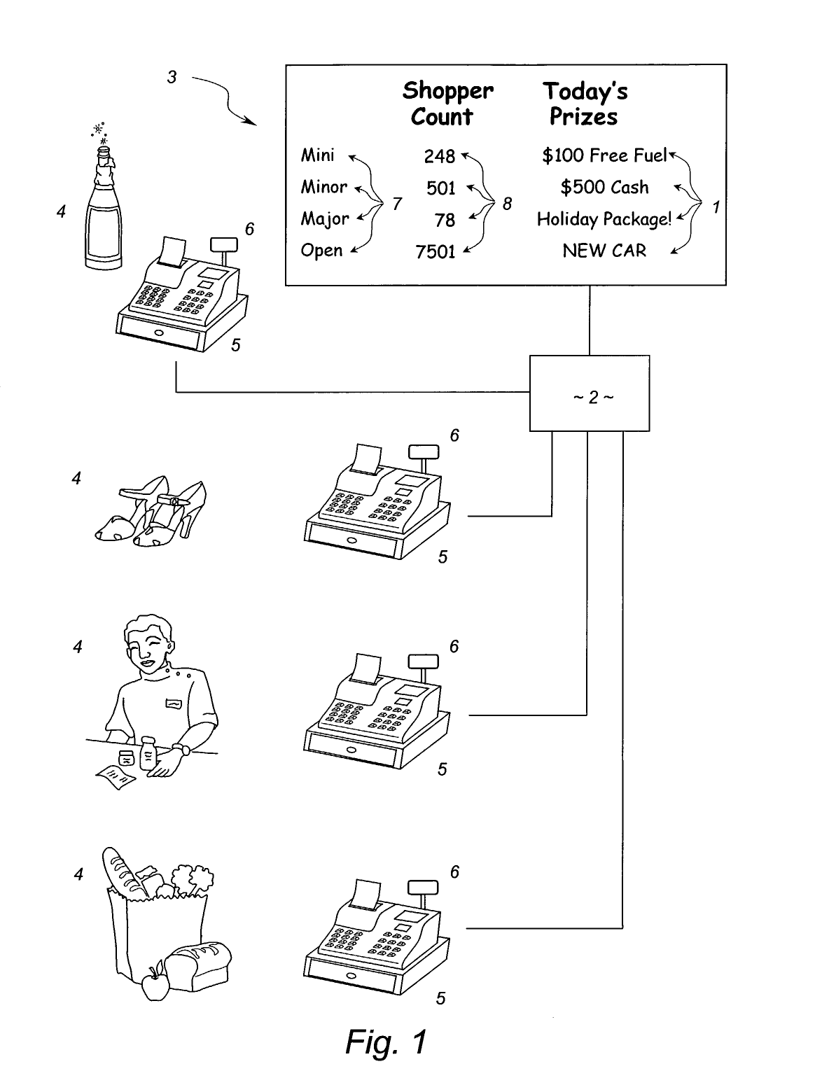

Referring to FIG. 1, a basic schematic representation of the system is shown as if it were applied to the various retailers 4 within a shopping center. However, this is purely illustrative as the incentive system is not limited to retailers operating from a single shopping centre, nor is it limited to the consumption of goods and services at the retail level. Furthermore, the system can be used by as many different retailers that the system administrators can manage or the incentive system can be administered by an individual business as an “in house” promotional scheme.

In the system shown in FIG. 1, the prizes 1 are arbitrarily selected on a daily basis and displayed on one or more prominent screens 3. However, the system could just as easily be configured for prizes selected on a weekly basis or monthly basis or a mixture of different time periods. For example, there may be daily prizes, weekly prizes and a large monthly prize. These factors will be a matter of choice for the system administrators (usually the shopping centre management in consultation with the participating retailers 5).

The system controller 2 is programmed to select the number of transactions 8 that will occur before it awards each of the prizes 1. An arbitrary number of transactions may be selected, so that the prize is awarded every, say, one thousand transactions. However, randomly selecting the trigger number of transactions will help maintain the incentive immediately after the award of prize.

In order to provide several different categories of prizes 7 of different value, it is necessary to have some control over the frequency that the prizes 7 are won. This can be done by programming the controller 2 such that the transaction number 8 that will trigger the award of a “mini” category prize is randomly selected from a range of possible transaction numbers between 1 and 1,000. As the minor prize has a higher cost than the mini prize, the shopping centre would want to award that less frequently. Therefore, the transaction number 8 would be randomly selected from a range of possible transaction numbers extending from 1 to say 2,000. Similarly, the cost of the major prize would dictate that the transaction number that triggers the award of this prize is selected from a range of say 500 to 3,000. On this basis, the cost of a new car would require the relevant transaction number to be selected from an even higher range of numbers, for example, 1,000 to 100,000.

Alternatively, the frequency with which the prizes 1 are awarded may be controlled by only allowing higher value transactions (and therefore lower frequency transactions) to be eligible for the higher value prizes. In this way, the randomly selected transaction number 8 that will trigger the award of any of the prizes is selected from a range between 1 and 1,000. However, to qualify for the open prize, the transaction value must be over $100. Transactions between $20.01 and $100.00 will qualify for the major prize while transactions between $10.01 and $20.00 qualify for the minor prize and customers that spend between $5 and $10 qualify for the mini prize.

Regardless of which method is adopted to control the winning frequency of each prize, it can be advantageous to program the controller 2 such that only transactions exceeding a threshold value will be considered for any prizes. This would discourage consumers from deliberately separating their purchases into as many separate individual transactions as possible. Obviously, such behavior could be highly detrimental to the speed and efficiency of processing transactions at the check out.

The system is well suited for use with electronic cash registers 5 which can be easily linked to the controller 2. Similarly electronic cash registers 5 can incorporate their own miniature display screens 6 which can be used to keep the customers informed of the prizes 1 as well as display the transaction numbers 8 as they scroll towards the trigger value. The individual cash register screens 6 can be used to inform the winning customer that they have won immediately after the trigger transaction number has been completed. Of course, the other register screens 6 and the main screens 3 would also need to inform customers when a prize has been won.

The incentive system according to the present invention is easily applied to large shopping centers (also called shopping malls) as they often provide locations for the large display screens 3. Several prominent display screens 3 in a shopping centre ensure that the majority of customers can view the prizes 1 being offered as well as the current value of the transaction numbers 8. As discussed above the individual display screens 6 attached to each of the electronic registers 5 provide a useful complimentary form of communicating these details to the customers.

The electronic cash registers 5 are well suited to this system as they can be easily configured to capture and transmit many different details relating to each transaction. For example, it would be trivial for the modern cash register to monitor and transmit a range of transaction details, such as the amount of the transaction, the purchase of particular products, or any products from particular manufacturers, whether or not the transaction was paid for by credit card, which type of credit card was used, and so on. It will be appreciated that the respective trigger values for each of the prizes could be based on combinations of this information and facilitates any one-off special promotions associated with the sale of products from a particular manufacturer. However, for simplicity, any on-going or regular prize giveaways would most conveniently be selected on the basis of a randomly chosen transaction number 8. In this way the controller 2 only needs to be programmed such that it recognizes the qualifying transactions from each of the registers 5 and increments the relevant transaction number totals 8 by one. Furthermore, it is then a simple task to compare the current transaction number total 8 to the randomly selected trigger transaction number each time the total increments.

The regular or on-going prizes can be easily varied or tailored to any special promotions. For example, Christmas promotions can incorporate suitable theme related prizes. Likewise, major sporting events, like the Olympics or football grand finals, can also be incorporated or somehow related to the prizes on offer.

The incentive system also allows the administrators to increase or decrease the value of the prizes on offer in response to variations in the levels of patronage experienced by the shopping centre. For example, if a competing shopping center has a promotional campaign that is affecting patronage, the administrators can simply decide to increase the value of the prizes on offer in order to enhance the incentive for shoppers to return. Likewise, any cyclical or regular periods of lower patronage, such as the time between traditional sale periods, can have higher value prizes in an attempt to entice customers to the shopping centre. Conversely, the prizes won can be less enticing during the traditionally busy periods for the shopping center. In this way, the system according to the present invention, offers greater flexibility than other incentive systems where the prizes must be in the form of cash and must be a set proportion of the accumulated spending of the customers.

The present system also allows the administrators to offer prizes that are supplied by participating retailers. Obviously retailers can supply the prizes at a “wholesale” cost rather than the “retail” cost. Therefore this system can provide the same incentive to shoppers for less expense compared to systems that are limited to offering cash prizes.

The present invention has been described herein by way of example only. Skilled workers in this field will readily recognize many variations and modifications which do not depart from the spirit and scope of the broad inventive concept. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A consumer incentive system for awarding a prize to at least one consumer comprising:
at least one electronic transaction device which facilitate the purchase of goods or services;
a system controller linked to the at least one electronic device for receiving selected transaction information, wherein the selected transaction information includes at least one transaction detail selected from the group consisting of:
transaction number;
transaction time;
transaction amount;
transaction type; and
category of consumer;
wherein the controller is programmable to:
accumulate the at least one transaction detail and maintain a progressive total of the at least one transaction detail;
select an accumulated total of the at least one transaction detail to be a trigger value;
compare the progressive total to the trigger value; and
award the prize to the consumer involved in the transaction which causes the progressive total to meet or exceed the trigger value.

2. A consumer incentive system according to claim 1 wherein a prominently positioned display screen is linked to the controller for showing consumers the prize.

3. A consumer incentive system according to claim 2 wherein at least two separate businesses each have at least one electronic transaction device.

4. A consumer incentive system according to claim 3 wherein each of the separate businesses has at least one of the display screens showing the prize.

5. A consumer incentive system according to claim 4 wherein the controller randomly selects a transaction number as the trigger value.

6. A consumer incentive system according to claim 1 wherein several prizes are arbitrarily selected and the controller assigns each of the prizes a respective trigger value.

7. A consumer incentive system according to claim 1 wherein the respective trigger values are randomly selected from at least one of different types and different combinations of the transaction details.

8. A consumer incentive system according to claim 7 wherein each of the displays show the prizes and the associated type of transaction detail from which the trigger value was randomly selected.

9. A consumer incentive system according to claim 8 wherein only transactions having a value within a certain range will be added to the progressive total and/or considered eligible for the award one of the prizes.

10. A consumer incentive system according to claim 9 wherein the transaction detail that is accumulated is the transaction number.

11. A consumer incentive system according to claim 10 wherein the prizes are each selected from at least one of goods and services provided by the businesses using the incentive system.

12. A consumer incentive system according to claim 11 wherein the controller is adapted to randomly select transaction numbers to be the respective trigger values for each of the prizes, wherein the controller is programmed with an upper limit and a lower limit of transaction numbers from which the respective trigger value transaction numbers are randomly selected for each prize such that the respective transaction numbers are selected from different ranges of transaction numbers, and the range assigned to each prize can be used as a rough guide as to the cost of each of the selected prizes.

13. A consumer incentive system according to claim 1 wherein the accumulated total of the transaction detail chosen to be the trigger value is randomly selected thereby making the trigger value randomly generated.

14. A method of awarding a prize to at least one consumer purchasing goods and/or services via at least one electronic transaction device linked to a system controller, the method comprising:
transmitting selected transaction information from the at least one transaction device to the controller, wherein the selected transaction information includes at least one transaction detail selected from the group consisting of:
transaction number;
transaction time;
transaction amount;
transaction type; and
category of consumer;
accumulating at least one of transaction details and maintaining a progressive total of the at least one of the transaction details;
selecting an accumulated total to be a trigger value;
comparing the progressive total to the trigger value; and
awarding the prize to the consumer involved in the transaction which causes the progressive total to meet or exceed the trigger value.

15. A method according to claim 14 wherein the accumulated total of the transaction detail chosen to be the trigger value is randomly selected thereby making the trigger value randomly generated.

16. A method according to claim 15 wherein a prominently positioned display screen is linked to the controller for showing consumers the prize.

17. A method according to claim 16 wherein at least two separate businesses each have at least one electronic transaction device.

18. A method according to claim 17 wherein each of the separate businesses has at least one of the display screens showing the prize.

19. A method according to claim 14 wherein the controller randomly selects a transaction number as the trigger value.

20. A method according to claim 14 wherein several prizes are arbitrarily selected and the controller assigns each of the prizes a respective trigger value.

21. A method according to claim 20 the respective trigger values are randomly selected from different types or combinations of the transaction details.

22. A method according to claim 21 wherein each of the displays show the prizes and the associated type of transaction detail from which the trigger value was randomly selected.

23. A method according to claim 22 wherein only transactions having a value within a certain range will be added to the progressive total and or considered eligible for the award one of the prizes.

24. A method according to claim 23 wherein the transaction detail that is recorded and accumulated is the transaction number.

25. A method according to claim 24 wherein the prizes are each selected from goods or services provided by the businesses using the incentive system.

26. A method according to claim 14 wherein the controller is adapted to randomly select transaction numbers to be the respective trigger values for each of the prizes, wherein the controller is programmed with an upper limit and a lower limit of transaction numbers from which the respective trigger value transaction numbers are randomly selected for each prize such that the respective transaction numbers are selected from different ranges of transaction numbers, and the range assigned to each prize can be used as a rough guide as to the cost of each of the selected prizes.

27. A system controller for a system of awarding a prize to at least one consumer of goods and/or services purchased using at least one electronic transaction devices, the system controller comprising:
a microprocessor;
means adapted to receive selected transaction information from the at least one electronic transaction device, wherein the selected transaction information including at least one transaction detail selected from the group consisting of:
transaction number;
transaction time;
transaction amount;
transaction type; and
category of consumer;
wherein the microprocessor is programmable to:
accumulate at least one of the transaction details and maintain a progressive total of the at least one transaction detail;
select an accumulated total of the transaction detail to be a trigger value; and
compare the progressive total to the trigger value and identify the consumer involved in the transaction that causes the progressive total to meet or exceed the trigger value such that the consumer is the prize winner.

28. A system controller according to claim 27 wherein the accumulated total of the transaction detail chosen to be the trigger value, is randomly selected thereby making the trigger value randomly generated.

29. A system controller according to claim 28 wherein prominently positioned display screen is linked to the controller for showing consumers the prize.

30. A system controller according to claim 29 wherein at least two separate businesses each have at least one electronic transaction device.

31. A system controller according to claim 30 wherein each of the separate businesses has at least one of the display screens showing the prize.

32. A system controller according to claim 27 wherein the controller randomly selects a transaction number as the trigger value.

33. A system controller according to claim 27 wherein several prizes are arbitrarily selected and the controller assigns each of the prizes a respective trigger value.

34. A system controller according to claim 33 wherein the respective trigger values are randomly selected from different types or combinations of the transaction details.

35. A system controller according to claim 34 wherein each of the displays show the prizes and the associated type of transaction detail from which the trigger value was randomly selected.

36. A system controller according to claim 35 wherein only transactions having a value within a certain range will be added to the progressive total and or considered eligible for the award one of the prizes.

37. A system controller according to claim 36 wherein the transaction detail that is recorded and accumulated is the transaction number.

38. A system controller according to claim 37 wherein the controller is adapted to randomly select transaction numbers to be the respective trigger values for each of the prizes, wherein the controller is programmed with an upper and lower limit of transaction numbers from which the respective trigger value transaction numbers are randomly selected for each prize, such that the respective transaction numbers are selected from different ranges of transaction numbers, and the range assigned to each prize can be used as a rough guide as to the cost of each of the selected prizes.

39. A system controller according to claim 27 wherein the prizes are each selected from goods or services provided by the businesses using the incentive system.
